(19) United States
(12) Patent Application Publication
(10) Pub. No.: US 2024/0194202 A1
(43) Pub. Date: Jun. 13, 2024

(54) ARTIFICIAL INTELLIGENCE CAPTIONS USING AN ENSEMBLE METHOD FOR AUDIO TEMPO AND PITCH

(71) Applicant: INTERNATIONAL BUSINESS MACHINES CORPORATION, ARMONK, NY (US)

(72) Inventor: Willie L. Scott, II, Austin, TX (US)

(21) Appl. No.: 18/064,977

(22) Filed: Dec. 13, 2022

(51) Int. Cl. G10L 15/26; G10L 25/03; H04N 21/488

(52) U.S. Cl. CPC G10L 15/26; G10L 25/03; H04N 21/4884

(57) ABSTRACT

According to one embodiment, a method, computer system, and computer program product for generating captions is provided. The present invention may include capturing input audio comprising audiovisual content; processing the input audio to extract an input rate of speech, input word timings, and input word predictions; generating one or more new audio files by altering the input rate of speech of the input audio to fall within a pre-determined range; processing the one or more new audio files to extract new word timings and a new word predictions; creating a mapping that pairs the input word timings with corresponding new word timings; selecting a word prediction for each paired input word timing and new word timing based on the mapping; and integrating the selected word predictions into the audiovisual content for display.

### BACKGROUND

The present invention relates, generally, to the field of computing, and more particularly to auto-captioning.

Closed captioning (CC) and subtitling are both processes of displaying text on a television, video screen, or other visual display to provide additional or interpretive information. Both are typically used as a transcription of the audio portion of a program as it occurs (either verbatim or in edited form), sometimes including descriptions of non-speech elements. Other uses have included providing a textual alternative language translation of a presentation's primary audio language that is usually burned-in (or “open”) to the video and un-selectable. Improvements in speech recognition technology means that live captioning may be fully or partially automated; the field concerned with generating live captions in a fully automated fashion is that of auto-captioning.

### SUMMARY

According to one embodiment, a method, computer system, and computer program product for generating captions is provided. The present invention may include capturing input audio comprising audiovisual content; processing the input audio to extract an input rate of speech, input word timings, and input word predictions; generating one or more new audio files by altering the input rate of speech of the input audio to fall within a pre-determined range; processing the one or more new audio files to extract new word timings and a new word predictions; creating a mapping that pairs the input word timings with corresponding new word timings; selecting a word prediction for each paired input word timing and new word timing based on the mapping; and integrating the selected word predictions into the audiovisual content for display.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a caption generation process according to at least one embodiment; and

FIG. 3 is a component diagram illustrating an implementation of the caption generation program according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to auto-captioning. The following described exemplary embodiments provide a system, method, and program product to, among other things, automatically generate captions from audio files that have been shifted in rate of speech to fall within a predetermined range.

As previously described, auto-captioning is the field concerned with generating and displaying captions for a live video broadcast in a fully automated fashion. Auto-captioning may entail generating captions using speech-to-text or automatic speech recognition software, as well as Artificial Intelligence (AI) based algorithms. However, live transcription of audio into text for captions is an extremely complex process; vocalizations vary in terms of accent, pronunciation, articulation, roughness, nasality, pitch, volume, and speed. Speech may be distorted by background noise, echoes, electrical characteristics, et cetera. Vocabulary can be hard to recognize if it contains confusing words, and error rates in transcription increase as the vocabulary size grows. As a result, many auto-captioning methods in the art suffer from issues with accuracy and high error rates. However, as captions are the only way by which those with hearing issues can experience the audio component of a video broadcast, legislation has mandated that certain content, such as educational videos, be made accessible to people with disabilities. Furthermore, legislation has established a requirement for an accuracy rate of 98.6%+ with respect to such content. Existing AI-generated captioning methods in the art are unable to achieve this accuracy rate. Choo et al. showed that STT recognition performed best when the rate of speech was between 120-160 words per minute. As such, it may be advantageous to, among other things, implement an auto-caption generation system that employs artificial intelligence to alter the input audio tempo and pitch to between 120-160 words per minute, and then using an ensemble method to produce STT output based on the tempo- and pitch-shifted input audio. Therefore, the present embodiment has the capacity to improve the technical field of auto-captioning by shifting input audio of any speed to match a rate of speech at which STT performs best, thereby improving the accuracy and reducing the error rate of caption generation, and by extension improving the ability of viewers to accurately experience the audio component of an audiovisual broadcast even if they, for whatever reason, are incapable of hearing it.

According to one embodiment, the invention is a method of receiving input audio, generating a new audio file that alters the tempo of the input audio, using an ensemble method to generate output text for captions based on the input audio, and integrating the captions into an audiovisual broadcast.

In some embodiments of the invention, the system may receive input audio, either by recording the input audio using one or more microphones operated by or otherwise connected to the system, or by receiving the input audio from some external source such as a streaming service over a network. The system may extract input audio from audiovisual content; in some embodiments, the system may extract input audio from audiovisual content in real-time as it is being streamed. In some embodiments of the invention, the system may pre-process the input audio by analyzing the input audio to predict text, utterance boundaries, word timings, et cetera; the output of this pre-processing step may be stored in a data structure as input audio data. Predicting text may entail identifying written words that the system determines to best match a section of audio which corresponds to a single word or paralinguistic sound, such that the audio is most likely to be the spoken form of that word. The section may comprise the timestamp delineating the beginning of the section, and/or the timestamp delineating the end of the section. The timestamps may correspond with the time at which the section occurs within the audiovisual content. The written word corresponding with a given section of audio may herein be referred to as a prediction, predicted word, or word prediction.

In some embodiments of the invention, the system may generate a new audio file by calculating a rate of speech S from the information extracted from the input audio in the pre-processing step. The system may multiply the last word timing, in seconds, by 60, and then divide by the total number of words predicted to produce the rate of speech S. In some embodiments, the system may generate a single new audio file that alters the tempo of the input audio by a coefficient R, while maintaining the same pitch, in order to prevent distortion. Coefficient R can be calculated from S*R=120; the coefficient R attempts to alter the rate of speech in the new audio file to be near 120 words per minute. In some embodiments of the invention, the system may generate a plurality of new audio files by altering the tempo of the input audio by a coefficient R while maintaining the same pitch, but where coefficient R is in the range 120<=S*R<=160. In other words, in such embodiments the coefficient R attempts to alter the rate of speech in the new audio files to be anywhere between 120 and 160 words per minute. Each of the plurality of new audio files may be at a different tempo between 120 and 160 words per minute. The more new audio files generated, the more robust the prediction, although this may come at the cost of increased computational cost. In some embodiments of the invention, the system may pre-process the one or more new audio files by analyzing the new audio files to predict text, utterance boundaries, word timings, et cetera; the output of this pre-processing step may be stored in a data structure as new audio data.

In some embodiments of the invention, the system may generate a mapping between predictions in the input audio data and the new audio data. The new audio is based on the input audio, and as such, even though the new audio has been shifted in tempo, the new audio and input audio are otherwise comprised of the same spoken words, sounds, and other linguistic characteristics. For this reason, the new audio and input audio comprise the same number and arrangement of discrete sections, where each section corresponds to a single word or paralinguistic sound, although the sections from the new audio differ in length from those of the input audio due to the differing rate of speech. However, because the system may predict words for the input audio and the new audio separately, and because the new audio is of a different tempo than the input audio, the system may predict different words as pertaining to analogous section of audio in the input audio and new audio. The system may, therefore, compare the input audio and new audio to number the sections, and identify what words have been predicted for each section. The system may store these predictions in a data structure along with the section of the input audio data to which they correspond. Where two or more predictions for a given section comprise identical words, the system may store that word as a single entry.

In some embodiments of the invention, the system may utilize an ensemble method to generate output text for captions. An ensemble method may be used to generate the output predictions by iterating through each section of the audio and comparing the associated word predictions, including capitalization and punctuation, and selecting a single prediction to output for that section. In some embodiments, for example where there is a single new audio file, the system may consult the mapping to determine what words have been predicted for a given audio section; if the predictions match, and/or there is only a single word stored in association with a given segment, the system may output the single word for that section along with the corresponding section from the input audio file. However, if the predictions do not match, and/or there are two predictions for a given segment, the system may output the word prediction from the new audio data along with the corresponding section from the input audio file.

In some embodiments, for example where there are multiple new audio files, the system may consult the mapping to determine what words have been determined for a given audio section; if all predictions match, and/or there is only a single word stored in association with a given segment, the system may output the single word for that segment along with the corresponding section from the input audio file. Otherwise, for example where one or more predictions differ for a given section, the system may utilize any number or type of algorithms to reconcile the disagreement and select a prediction to output, such as O (n lg n) Sorting, the Boyer-Moore Algorithm, the Distributed Boyer-Moore Algorithm, et cetera. For example, the system may use a democratic approach by calculating the sum of unique word predictions across the input audio data and new audio data for the given section and outputting the reconciled predictions. In some embodiments, the system may employ the Boyer-Moore Majority Voting Algorithm to find the majority element among the given elements that has more than N/2 occurrences; the system may output the prediction found to be the majority element for that section along with the corresponding section from the input audio file.

Once the system has output a prediction and its corresponding section for each section of the audio, the system may integrate the output predictions as text captions into an audiovisual content. The predictions may be aligned with the audio of the audiovisual content by matching the section with the corresponding timecode of the audiovisual content. The text captions may be integrated into the audiovisual content through a variety of methods: for example, the subtitle text may be irreversibly merged into original video frames of the audiovisual content, such that no special equipment or software is required for playback; the text caption may be provided as separate video frames that are overlaid onto the original video stream of the audiovisual content while playing, and may be encoded as images with minimal bitrate and number of colors; or the text caption may be rendered into instructions provided with time stamps to a given media player program, which may render the text caption during playback. In some embodiments, the system may generate and integrate the output predictions in real-time as the audiovisual content is being broadcast live. In some embodiments, the system may generate the output predictions an hour or more prior to the audiovisual content being broadcast and integrate the output predictions as captions in real-time as the audiovisual content is being broadcast live. In some embodiments, the system may generate and integrate the output predictions an hour or more prior to the audiovisual content being broadcast.

The following example illustrates how the invention may determine output predictions in an exemplary embodiment where there is only one new audio file:

| Input | Input | | | | |
|---|---|---|---|---|---|
| Audio | Audio | New Audio | New Audio | Output | Output |
| Section | Prediction | Section | Prediction | Section | Prediction |
| t0 | cease | tA | See | t0 | See |
| t1 | cane | tB | Jane | t1 | Jane |
| t2 | running | tC | running | t2 | running |
| t3 | home | tD | home | t3 | home |
| t4 | | tE | . | t4 | . |

Here, the system has performed a mapping step, and determined that sections t0 through t4 of the input audio respectively correspond with sections tA-tE of the new audio. The system then identifies the predictions corresponding to each associated pair of segments. For example, since to and tA are corresponding sections, the system has identified two predictions for those sections: “cease” and “See.” Because the predictions differ, the system may select the prediction made for the new audio file, “See,” because the tempo-shifted new audio file is more likely to be accurate than the input audio. The system may also output the corresponding audio section from the input audio, section t0.

The following example illustrates how the invention may select an output prediction for an audio section from multiple candidate output predictions in an exemplary embodiment where there are multiple new audio files:

| | New | New | New | New | New | New | |
|---|---|---|---|---|---|---|---|
| | Audio A | Audio B | Audio C | Audio D | Audio E | Audio F | Output |
| | Prediction | Prediction | Prediction | Prediction | Prediction | Prediction | Prediction |
| New | cause | cause | Cars | cars | cars | cars | cars |
| Audio | | | | | | | |
| Section | | | | | | | |
| t0 | | | | | | | |

Here, there are six new audio files, file A through file F; accordingly, for section t0 of the original audio file, there are six corresponding predictions, one for each new audio file. The system may select an output prediction from among these six options by utilizing the Boyer-Moore Majority Voting Algorithm; the system may input the candidate predictions as follows:

Input: {cause, cause, cars, cars, cars, cars}

Using the algorithm, the system may determine that, because the length of the array is 6, the frequency of the word “cars” is 4>6/2, and the frequency of the word “cause” is 2<6/2, the prediction “cars” is the majority element. The system may accordingly output “cars” as the output prediction for section t0.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to automatically generate captions from audio files that have been shifted in rate of speech to fall within a predetermined range.

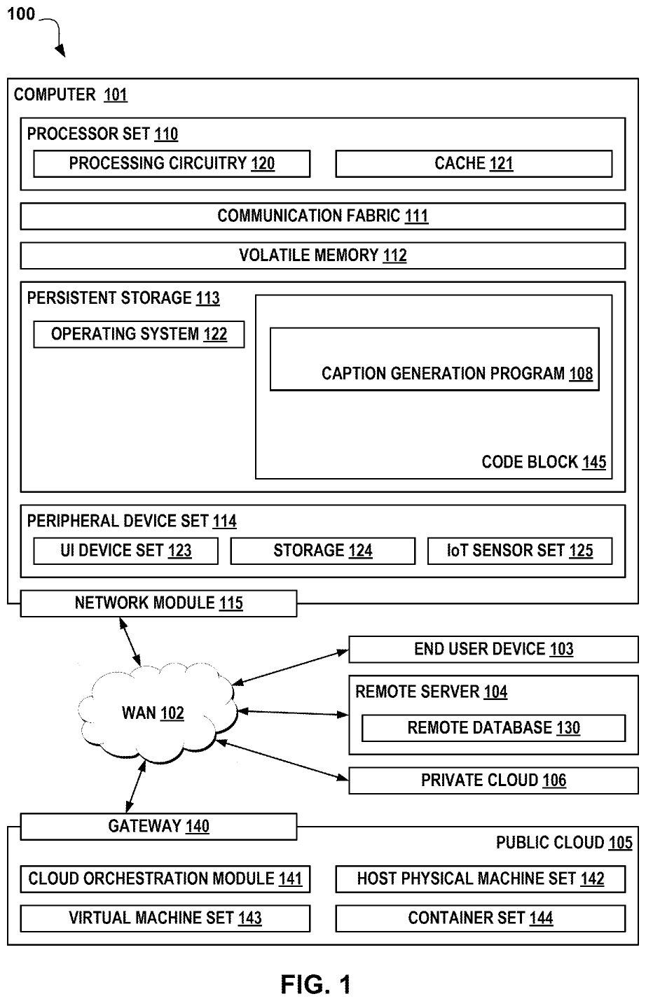

Referring now to FIG. 1, computing environment 100 contains an example of an environment for the execution of at least some of the computer code involved in performing the inventive methods, such as code block 145, which may comprise caption generation program 108. In addition to code block 145, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 145, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 145 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 145 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

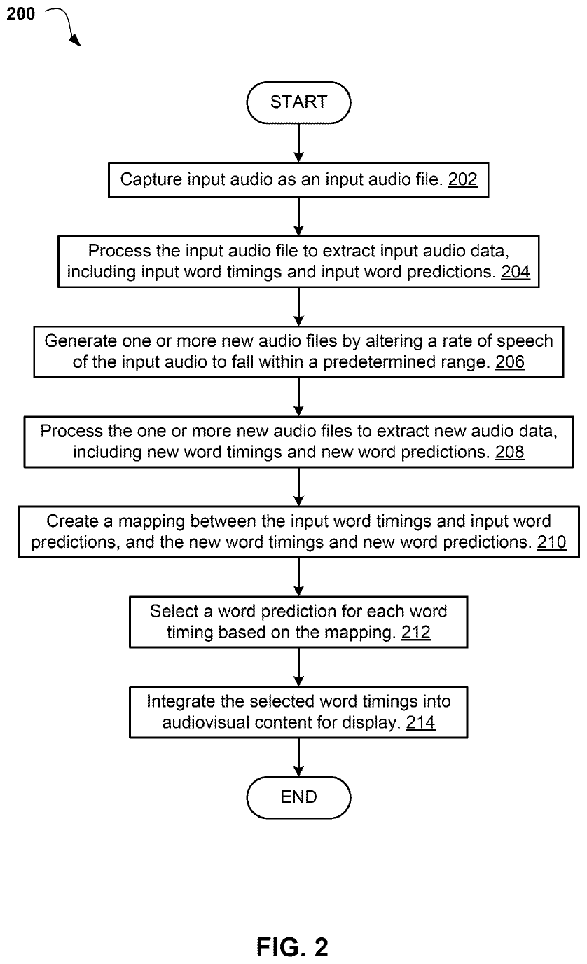

According to the present embodiment, the caption generation program 108 may be a program capable of automatically generate captions from audio files that have been shifted in rate of speech to fall within a predetermined range. The caption generation program 108 may, when executed, cause the computing environment 100 to carry out a caption generation process 200. The caption generation process 200 may be explained in further detail below with respect to FIG. 2. In embodiments of the invention, the caption generation program 108 may be stored and/or run within or by any number or combination of devices including computer 101, end user device 103, remote server 104, private cloud 106, and/or public cloud 105, peripheral device set 114, and server 112 and/or on any other device connected to WAN 102. Furthermore, caption generation program 108 may be distributed in its operation over any number or combination of the aforementioned devices.

Referring now to FIG. 2, an operational flowchart illustrating a caption generation process 200 is depicted according to at least one embodiment. At 202, the caption generation program 108 may capture input audio as an input audio file. The caption generation program 108 may capture input audio by recording the input audio using one or more microphones operated by or otherwise connected to the caption generation program 108. Additionally, or alternatively, the caption generation program 108 may receive the input audio from some external source such as a data repository or streaming service over a network, by extracting the input audio directly from audiovisual content in real time as it is streamed, et cetera. The caption generation program 108 may save the captured input audio in a data structure as an input audio file.

At 204, the caption generation program 108 may process the input audio file to extract input audio data, including input word timings and input word predictions. The caption generation program 108 may process the input audio by analyzing the input audio to predict text, utterance boundaries, word timings, et cetera; the output of this pre-processing step may be stored in a data structure as input audio data. Predicting text may entail identifying written words that the caption generation program 108 determines to best match a section of audio which corresponds to a single word or paralinguistic sound, such that the audio is most likely to be the spoken form of that word. The word timing, or section, may comprise the timestamp delineating the beginning of the section, and/or the timestamp delineating the end of the section. The timestamps may correspond with the time at which the section occurs within the audiovisual content.

At 206, the caption generation program 108 may generate one or more new audio files by altering a rate of speech of the input audio to fall within a predetermined range. The caption generation program 108 may generate a new audio file by calculating a rate of speech S from the information extracted from the input audio in the pre-processing step. The caption generation program 108 may multiply the last word timing, in seconds, by 60, and then divide by the total number of words predicted to produce the rate of speech S. In some embodiments, the caption generation program 108 may generate a single new audio file that alters the tempo of the input audio by a coefficient R, while maintaining the same pitch, in order to prevent distortion. Coefficient R can be calculated from S*R=120; the coefficient R attempts to alter the rate of speech in the new audio file to be near 120 words per minute. In some embodiments of the invention, the caption generation program 108 may generate a plurality of new audio files by altering the tempo of the input audio by a coefficient R while maintaining the same pitch, but where coefficient R is in a predetermined range. The predetermined range may be any range found to improve the accuracy of text-to-speech methods and may be 120<=S*R<=160. In other words, in such embodiments the caption generation program 108 attempts to alter the rate of speech using coefficient R to fall anywhere between 120 and 160 words per minute. The new audio files may be stored in a data structure.

At 208, the caption generation program 108 may process the one or more new audio files to extract new audio data, including new word timings and new word predictions. The caption generation program 108 may process the one or more new audio files by analyzing the new audio files to predict text, utterance boundaries, word timings, et cetera; the output of this pre-processing step may be stored in a data structure as new audio data.

At 210, the caption generation program 108 may create a mapping between the input word timings and input word predictions, and the new word timings and new word predictions. The new audio is based on the input audio, and as such, even though the new audio has been shifted in tempo, the new audio and input audio are otherwise comprised of the same spoken words, sounds, and other linguistic characteristics. For this reason, the new audio and input audio comprise the same number and arrangement of discrete sections, where each section corresponds to a single word or paralinguistic sound, although the sections from the new audio differ in length from those of the input audio due to the differing rate of speech. However, because the caption generation program 108 may predict words for the input audio and the new audio separately, and because the new audio is of a different tempo than the input audio, the caption generation program 108 may predict different words as pertaining to analogous section of audio in the input audio and new audio. The caption generation program 108 may, therefore, compare the input audio and new audio to number the sections, and identify what words have been predicted for each section. The caption generation program 108 may store these predictions in a data structure. Where two or more predictions for a given section comprise identical words, the caption generation program 108 may store that word as a single entry.

At 212, the caption generation program 108 may select a word prediction for each word timing based on the mapping. The caption generation program 108 may utilize an ensemble method to select the output predictions from provided input and new predictions by iterating through each section of the audio and comparing the associated word predictions, both input predictions and new predictions, and including capitalization and punctuation, and selecting a single prediction to output for that section. In some embodiments, for example where there is a single new audio file, the caption generation program 108 may consult the mapping to determine what words have been predicted for a given audio section; if the predictions match, and/or there is only a single word stored in association with a given segment, the caption generation program 108 may output the single word for that section along with the corresponding section from the input audio file. However, if the predictions do not match, and/or there are two predictions for a given segment, the caption generation program 108 may output the word prediction from the new audio data along with the corresponding section from the input audio file.

In some embodiments, for example where there are multiple new audio files, the caption generation program 108 may consult the mapping to determine what words have been determined for a given audio section; if all predictions match, and/or there is only a single word stored in association with a given segment, the caption generation program 108 may output the single word for that segment along with the corresponding section from the input audio file. Otherwise, for example where one or more predictions differ for a given section, the caption generation program 108 may utilize any number or type of algorithms to reconcile the disagreement and select a prediction to output. For example, the caption generation program 108 may use a democratic approach by calculating the sum of unique word predictions across the input audio data and new audio data for the given section and outputting the reconciled predictions. In some embodiments, the caption generation program 108 may employ the Boyer-Moore Majority Voting Algorithm to find the majority element among the given elements that has more than N/2 occurrences; the caption generation program 108 may output the prediction found to be the majority element for that section along with the corresponding section from the input audio file.

At 214, the caption generation program 108 may integrate the selected word timings into audiovisual content for display. Once the caption generation program 108 has output a prediction and its corresponding section for each section of the audio, the caption generation program 108 may integrate the output predictions as text captions into an audiovisual content. The predictions may be aligned with the audio of the audiovisual content by matching the section with the corresponding timecode of the audiovisual content. The text captions may be integrated into the audiovisual content through a variety of methods: for example, the subtitle text may be irreversibly merged into original video frames of the audiovisual content, such that no special equipment or software is required for playback; the text caption may be provided as separate video frames that are overlaid onto the original video stream of the audiovisual content while playing, and may be encoded as images with minimal bitrate and number of colors; or the text caption may be rendered into instructions provided with time stamps to a given media player program, which may render the text caption during playback. In some embodiments, the caption generation program 108 may generate and integrate the output predictions in real-time as the audiovisual content is being broadcast live. In some embodiments, the caption generation program 108 may generate the output predictions an hour or more prior to the audiovisual content being broadcast and integrate the output predictions as captions in real-time as the audiovisual content is being broadcast live. In some embodiments, the caption generation program 108 may generate and integrate the output predictions an hour or more prior to the audiovisual content being broadcast.

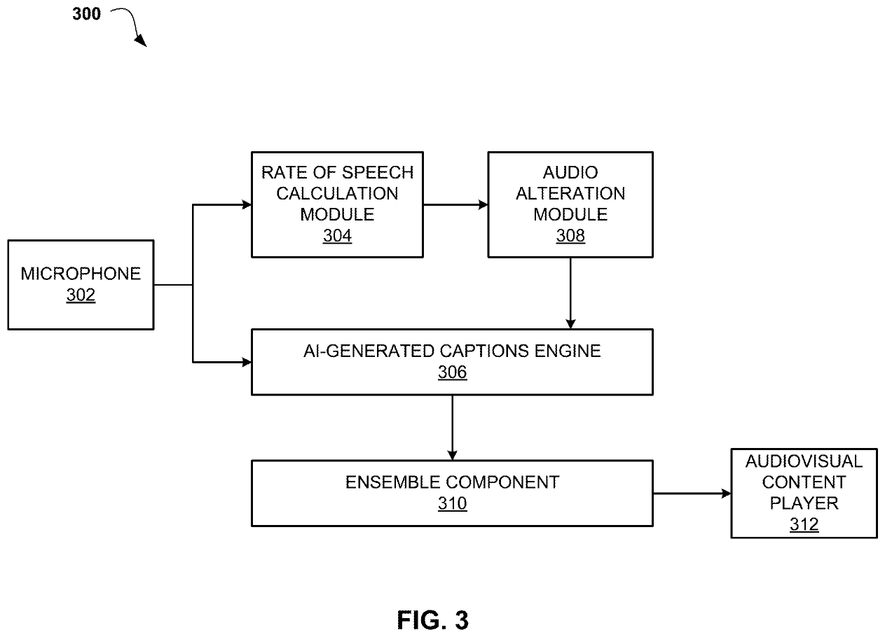

Referring now to FIG. 3, a component diagram 300 illustrating an implementation of caption generation program 108 is depicted according to at least one embodiment. Here, caption generation program 108 receives input audio at microphone 302. The input audio is then provided as inputs to both the rate of speech calculation module 304 and the AI-generated captions engine 306. The rate of speech calculation module 304 then processes the input audio to calculate a rate of speech associated with the input audio. The rate of speech calculation module 304 then provides the input audio and the calculated rate of speech to the audio alteration module 308, which creates one or more new audio files by shifting the rate of speech of the input audio according to a coefficient R such that the rate of speech of the one or more new audio files falls within a predetermined range. The audio alteration module 308 then provides the one or more new audio files to the AI-generated captions engine 306. The AI generated captions engine 306 accepts the input audio from the microphone 302 and the one or more new audio files from the audio alteration module 308 as inputs, extracts input audio data and new audio data, respectively, from the input audio and the one or more new audio files and produces an input prediction and a new prediction for each input word timing and each new word timing, respectively. The AI-generated captions engine 306 may then provide the input predictions and the new predictions to the ensemble component 310, which may utilize an ensemble method to choose a single word prediction for each word timing. The ensemble component 310 may then provide its word predictions and timings to the audiovisual content player 312, which converts the word predictions and timings into captions and displays them with the audiovisual content of which the input audio was originally a part.

It may be appreciated that FIGS. 2-3 provide only illustrations of individual implementations and do not imply any limitations with regard to how different embodiments may be implemented.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for generating captions, the method comprising:
capturing input audio comprising audiovisual content;
processing the input audio to extract an input rate of speech, a plurality of input word timings, and a plurality of input word predictions;
generating one or more new audio files by altering the input rate of speech of the input audio to fall within a pre-determined range;
processing the one or more new audio files to extract a plurality of new word timings and a plurality of new word predictions;
creating a mapping that pairs the plurality of input word timings with corresponding new word timings of the plurality of new word timings;
selecting a word prediction for each paired input word timing and new word timing based on the mapping; and
integrating the selected word predictions into the audiovisual content for display.

2. The method of claim 1, wherein the pre-determined range is between 120 words per minute and 160 words per minute.

3. The method of claim 1, wherein the selecting is performed using an ensemble method.

4. The method of claim 1, wherein the selecting is performed using a Boyer-Moore Majority Voting Algorithm.

5. The method of claim 1, wherein the input audio and the one or more new audio files have a same pitch.

6. The method of claim 1, wherein the selected word predictions are associated with the input word timings.

7. The method of claim 1, wherein the integrating comprises aligning the plurality of input word timings with one or more corresponding timecodes of the audiovisual content.

8. A computer system for generating captions, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
capturing input audio comprising audiovisual content;
processing the input audio to extract an input rate of speech, a plurality of input word timings, and a plurality of input word predictions;
generating one or more new audio files by altering the input rate of speech of the input audio to fall within a pre-determined range;
processing the one or more new audio files to extract a plurality of new word timings and a plurality of new word predictions;
creating a mapping that pairs the plurality of input word timings with corresponding new word timings of the plurality of new word timings;
selecting a word prediction for each paired input word timing and new word timing based on the mapping; and
integrating the selected word predictions into the audiovisual content for display.

9. The computer system of claim 8, wherein the pre-determined range is between 120 words per minute and 160 words per minute.

10. The computer system of claim 8, wherein the selecting is performed using an ensemble method.

11. The computer system of claim 8, wherein the selecting is performed using a Boyer-Moore Majority Voting Algorithm.

12. The computer system of claim 8, wherein the input audio and the one or more new audio files have a same pitch.

13. The computer system of claim 8, wherein the selected word predictions are associated with the input word timings.

14. The computer system of claim 8, wherein the integrating comprises aligning the plurality of input word timings with one or more corresponding timecodes of the audiovisual content.

15. A computer program product for generating captions, the computer program product comprising:
one or more computer-readable tangible storage medium and program instructions stored on at least one of the one or more tangible storage medium, the program instructions executable by a processor to cause the processor to perform a method comprising:
capturing input audio comprising audiovisual content;
processing the input audio to extract an input rate of speech, a plurality of input word timings, and a plurality of input word predictions;
generating one or more new audio files by altering the input rate of speech of the input audio to fall within a pre-determined range;
processing the one or more new audio files to extract a plurality of new word timings and a plurality of new word predictions;
creating a mapping that pairs the plurality of input word timings with corresponding new word timings of the plurality of new word timings;
selecting a word prediction for each paired input word timing and new word timing based on the mapping; and
integrating the selected word predictions into the audiovisual content for display.

16. The computer program product of claim 15, wherein the pre-determined range is between 120 words per minute and 160 words per minute.

17. The computer program product of claim 15, wherein the selecting is performed using an ensemble method.

18. The computer program product of claim 15, wherein the selecting is performed using a Boyer-Moore Majority Voting Algorithm.

19. The computer program product of claim 15, wherein the input audio and the one or more new audio files have a same pitch.

20. The computer program product of claim 15, wherein the selected word predictions are associated with the input word timings.
